(19) United States
(12) Patent Application Publication
(10) Pub. No.: US 2024/0396331 A1
(43) Pub. Date: Nov. 28, 2024

(54) ELECTRICITY MANAGEMENT APPARATUS

(71) Applicants: TOYOTA JIDOSHA KABUSHIKI KAISHA, Toyota-shi (JP); DENSO CORPORATION, Kariya-city (JP)

(72) Inventors: Akinori MORISHIMA, Naka-gun (JP); Yutaro IKAWA, Kariya-city (JP)

(73) Assignees: TOYOTA JIDOSHA KABUSHIKI KAISHA, Toyota-shi (JP); DENSO CORPORATION, Kariya-city (JP)

(21) Appl. No.: 18/672,713

(22) Filed: May 23, 2024

(30) Foreign Application Priority Data
May 24, 2023 (JP) 2023-085475

(51) Int. Cl. H02J 3/00; H02J 3/14

(52) U.S. Cl. CPC H02J 3/003; H02J 3/144; H02J 2203/10

(57) ABSTRACT

An electricity management apparatus (an aggregator server, an electricity generation business operator server) is an apparatus that manages adjustment power of electricity delivered to an electricity transmission and distribution business operator by a trading business operator (an aggregator, an electricity generation business operator). The electricity management apparatus is capable of controlling an adjustment system of supply and demand of electricity and includes: a memory that stores a predetermined program therein; and a processor that executes the predetermined program. The processor controls, by executing the predetermined program, the adjustment system so as to go through a period of time of maintaining a reference value of supply and demand of electricity by the adjustment system in a case where the reference value is crossed when a command value of supply and demand electricity to the adjustment system transitions from a first command value before change to a second command value after change.

### CROSS-REFERENCE TO RELATED APPLICATION

This application claims priority to Japanese Patent Application No. 2023-085475 filed on May 24, 2023, incorporated herein by reference in its entirety.

### BACKGROUND

### 1. Technical Field

The present disclosure relates to an electricity management apparatus and particularly relates to an electricity management apparatus that manages adjustment power of electricity delivered to an electricity transmission and distribution business operator by a trading business operator.

### 2. Description of Related Art

In recent years, a supply and demand adjustment market that is a market in which a trading business operator such as an aggregator procures adjustment power of electricity to be delivered to general electricity transmission and distribution business operators has been established. A virtual power plant (VPP) can be utilized in the supply and demand adjustment market. The VPP means to provide a function equivalent to that of an electricity generation plant by controlling (including a reverse power flow) an energy resource such as an electricity generation facility, an electricity accumulation facility, or a demand facility on the consumer side, and an energy resource such as an electricity generation facility or an electricity accumulation facility directly connected to an electricity system by an owner thereof or a third party such as an aggregator (for example, see Japanese Unexamined Patent Application Publication No. 2022-113460).

In the VPP, supply and demand adjustment of electricity can be performed with use of a demand response (DR). The DR means to change a supply and demand pattern of electricity as a result of a third party or an owner of an energy resource on the consumer side controlling the energy resource. The DR is mainly classified into a lowering DR that reduces the demand and increases the supply and a raising DR that increases the demand and reduces the supply depending on the pattern of the supply and demand control.

### SUMMARY

In supply and demand adjustment in the VPP, when an electricity generation amount by renewable energy (hereinafter also referred to as “re-energy”) fluctuates, a command value of the supply and demand may fluctuate. As a result, the command value may deviate from a reference value supposed for that time frame. The reference value is a value of the adjustment power of the supply and demand of electricity when a DR is not performed. Therefore, the reference value is a value that is less burdensome for the energy resource. When the command value fluctuates from a first command value to a second command value so as to cross the reference value, the following occurs. When the reference value is instantly passed through, a period of time that is less burdensome for the energy resource becomes an instant period of time although the reference value is passed through.

The present disclosure has been made in order to solve the problem described above, and an object thereof is to provide an electricity management apparatus capable of causing a period of time that is less burdensome for a system that adjusts supply and demand of electricity to be as long as possible.

An electricity management apparatus according to the present disclosure is an electricity management apparatus that manages adjustment power of electricity delivered to an electricity transmission and distribution business operator by a trading business operator. The electricity management apparatus is capable of controlling an adjustment system of supply and demand of electricity and includes: a memory that stores a predetermined program in the memory; and a processor that executes the predetermined program. The processor controls, by executing the predetermined program, the adjustment system so as to go through a period of time of maintaining a reference value of supply and demand of electricity by the adjustment system in a case where the reference value is crossed when a command value of supply and demand electricity to the adjustment system transitions from a first command value before change to a second command value after change.

According to the configuration as above, it becomes possible to go through a period of time of maintaining the reference value in a case where the reference value is crossed when the command value of the supply and demand electricity to the adjustment system transitions from the first command value to the second command value. As a result, it becomes possible to provide the electricity management apparatus capable of causing the period of time that is less burdensome for the system that adjusts the supply and demand of the electricity to be as long as possible.

The processor may control, by executing the predetermined program, the adjustment system with a goal of linearly changing the first command value to the second command value in a case where the reference value of supply and demand of electricity by the adjustment system is not crossed when the command value of supply and demand of electricity to the adjustment system transitions from the first command value before change to the second command value after change.

According to the configuration as above, it becomes possible to change the first command value to the second command value by a simple control.

The processor may control the speed of changing the supply and demand of electricity by the adjustment system in a period of time of transitioning from the first command value to the reference value and a period of time of transitioning from the reference value to the second command value to be a controllable maximum speed when the adjustment system is controlled to go through the period of time of maintaining the reference value.

According to the configuration as above, the period of time that is less burdensome for the system that adjusts the supply and demand of the electricity can be caused to be further longer.

According to the present disclosure, it becomes possible to provide the electricity management apparatus capable of causing the period of time that is less burdensome for the system that adjusts the supply and demand of the electricity to be as long as possible.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an outline of a configuration of an electricity management system according to an embodiment of the present disclosure;

FIG. 2 is a flowchart showing a flow of adjustment power related processing executed by an aggregator server in the present embodiment;

FIG. 3 is a diagram showing a change of supply and demand electricity exchanged with an electricity transmission and distribution business operator in the present embodiment; and

FIG. 4 is an enlarged diagram showing a change before and after a reference value in a case where the reference value is crossed in the change of the supply and demand electricity exchanged with the electricity transmission and distribution business operator in the present embodiment.

### DETAILED DESCRIPTION OF EMBODIMENTS

An embodiment of the present disclosure is described in detail below with reference to the drawings. The same or equivalent parts in the drawings are denoted by the same reference characters, and description thereof is not repeated.

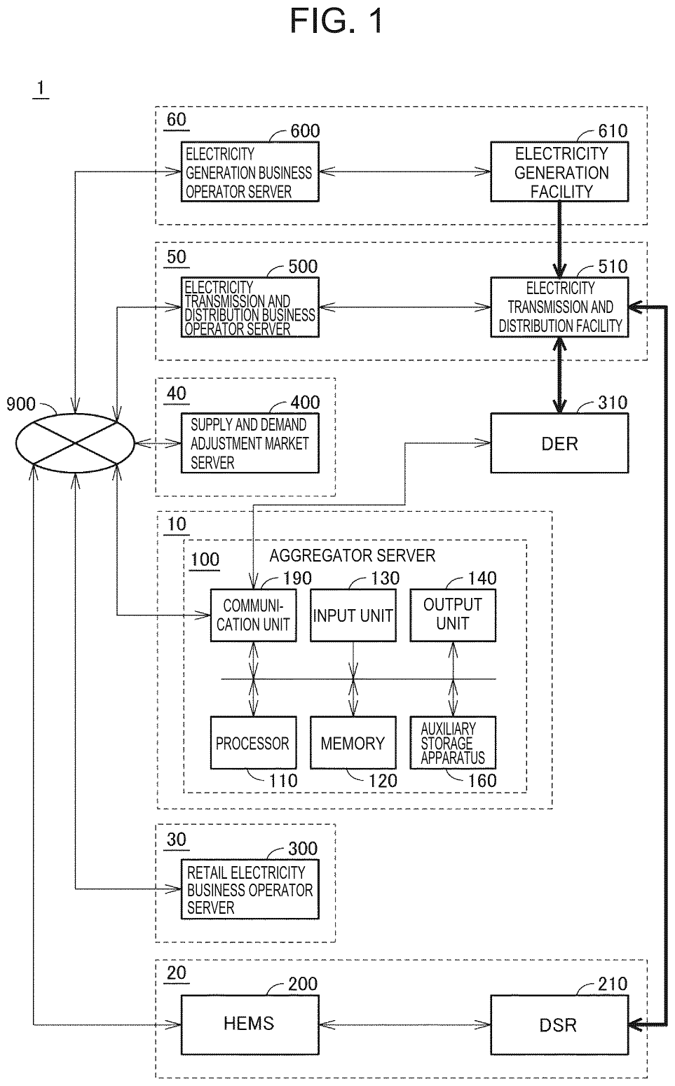

FIG. 1 is a block diagram showing an outline of a configuration of an electricity management system 1 according to an embodiment of the present disclosure. With reference to FIG. 1, an arrowed thick solid line indicates a flow of electricity, and arrowed thin solid lines and broken lines indicate flows of data. In the electricity management system 1, wheeling of electricity generated by an electricity generation business operator 60 to a consumer 20 that is a retail destination of a retail electricity business operator 30 (for example, a regional electricity company, a new electricity producer and supplier) is performed by an electricity transmission and distribution business operator 50 (for example, a general electricity transmission and distribution business operator).

A supply and demand adjustment market 40 is a market in which the electricity transmission and distribution business operator 50 procures adjustment power for performing supply and demand adjustment and frequency adjustment. The adjustment power includes primary adjustment power, secondary adjustment power (1), (2), and tertiary adjustment power (1), (2). Out of the above, the secondary adjustment power (2) and the tertiary adjustment power (1) are adjustment power delivered to the electricity transmission and distribution business operator 50 from the aggregator 10 or the electricity generation business operator 60 to respond to a prediction error with respect to a demand plan. The tertiary adjustment power (2) is adjustment power delivered to the electricity transmission and distribution business operator 50 from the aggregator 10 or the electricity generation business operator 60 to respond to a prediction error of renewable energy such as electricity by photovoltaic electricity generation or wind electricity generation. The bidding for the tertiary adjustment power (1), (2) is performed for a block (for example, three hours) of a target period in the supply and demand adjustment market 40 by the aggregator 10 or the electricity generation business operator 60 a day before the block. The aggregator 10 or the electricity generation business operator 60 has an obligation to deliver adjustment power (ΔkW) of a contract amount of a successful bidding result to the electricity transmission and distribution business operator 50 in the target block on the basis of a reference value (kW) of the demand for the electricity. The primary adjustment power and the secondary adjustment power (1), (2) are still not traded in the supply and demand adjustment market 40. The supply and demand adjustment market and the adjustment power are described in detail on websites of Ministry of Economy, Trade and Industry and Transmission & Distribution Grid Council, and the like.

The electricity generation business operator 60 has an electricity generation facility 610 (for example, a nuclear electricity generation facility, a thermal electricity generation facility, a hydraulic electricity generation facility, a photovoltaic electricity generation facility, a wind electricity generation facility, a geothermal electricity generation facility, and the like) that generates electricity, and a electricity generation business operator server 600 that manages an electricity generation business operation. The electricity transmission and distribution business operator 50 has an electricity transmission and distribution facility 510 that transmits and distributes electricity, and an electricity transmission and distribution business operator server 500 that manages an electricity transmission and distribution business operation. The electricity generation facility 610 and the electricity transmission and distribution facility 510 configure an electricity system (electricity grid). The supply and demand adjustment market 40 has a supply and demand adjustment market server 400 for managing the supply and demand of the electricity. The retail electricity business operator 30 has a retail electricity business operator server 300 that manages a retail electricity business operation.

The consumer 20 has a DSR 210 that includes at least one of a demand facility (for example, an electric appliance, a machine, and a chargeable or chargeable and dischargeable electrified vehicle), an electricity accumulation facility (for example, a stationary battery or a chargeable and dischargeable electrified vehicle), and an electricity generation facility (for example, a photovoltaic electricity generation facility or a wind electricity generation facility) that are energy resources connected to an electricity receiving point or lower, and a home energy management system (HEMS) 200 that manages the DSR 210.

The aggregator 10 has an aggregator server 100. The aggregator server 100 controls and manages a distributed energy resource (DER) 310 including at least one of an electricity generation facility or an electricity accumulation facility (for example, a chargeable electrified vehicle, a chargeable and dischargeable electrified vehicle, or a stationary battery) that is an energy resource directly connected to the electricity system or the DSR 210.

The aggregator server 100 includes a processor 110, a memory 120, an input unit 130, an output unit 140, an auxiliary storage apparatus 160, and a communication unit 190. The memory 120 includes a random access memory (RAM), a read only memory (ROM), a flash memory, and the like, and stores therein software such as a program executed by the aggregator server 100, data to be processed, and the like. The auxiliary storage apparatus 160 includes a hard disk drive (HDD), a solid state drive (SSD), a removable media drive, and the like, assists the memory 120, stores therein a larger capacity of data as compared to the memory 120, and stores therein software such as a program executed by the aggregator server 100, data to be processed, and the like. The input unit 130 includes an input device such as a keyboard and a mouse, and transmits information input from the input device by a user to the processor 110. The output unit 140 includes an output device such as a display and a speaker and outputs information received from the processor 110 to the output device. The communication unit 190 is a device that can communicate with an external apparatus such as another server via a communication network 900 such as the Internet and transmits and receives predetermined information to and from the external apparatus. The processor 110 processes data from the input unit 130 or the communication unit 190 or data stored in the memory 120 or the auxiliary storage apparatus 160 in accordance with the program stored in the memory 120 or the auxiliary storage apparatus 160, causes the output unit 140 or the communication unit 190 to output the data, and causes the memory 120 or the auxiliary storage apparatus 160 to store the data therein.

The retail electricity business operator server 300, the supply and demand adjustment market server 400, the electricity transmission and distribution business operator server 500, and the electricity generation business operator server 600 have a configuration similar to that of the aggregator server 100 described above.

The HEMS 200 can communicate with an external apparatus such as the aggregator server 100, the retail electricity business operator server 300, or the electricity transmission and distribution business operator server 500 via the communication network 900, control the supply and demand of the electricity at the DSR 210, and acquire a measured electricity amount from a smart meter that measures the electricity amount exchanged between the DSR 210 and the electricity system.

The HEMS 200 may have the function of the smart meter. The aggregator server 100 may directly or indirectly control and manage the DSR 210.

In supply and demand adjustment in a VPP in the electricity management system 1 as above, when the electricity generation amount by renewable energy fluctuates, a command value of the supply and demand may fluctuate. As a result, the command value may deviate from a reference value supposed for that time frame. The reference value is a value of the adjustment power of the supply and demand of electricity when a DR is not performed. Therefore, the reference value is a value that is less burdensome for the energy resource. When the command value fluctuates from a first command value to a second command value so as to cross the reference value, the following occurs. When the reference value is instantly passed through, a period of time that is less burdensome for the energy resource becomes an instant period of time although the reference value is passed through.

Thus, when a reference value of the supply and demand electricity by the DER 310 or the DSR 210 declared in advance is crossed when the command value of the supply and demand electricity to the DER 310 or the DSR 210 transitions from the first command value before the change to the second command value after the change, the processor 110 of the aggregator server 100 controls the DER 310 or the DSR 210 to go through a period of time of maintaining the reference value.

As a result, it becomes possible to go through a period of time of maintaining the reference value in a case where the reference value is crossed when the command value of the supply and demand electricity to the DER 310 or the DSR 210 transitions from the first command value to the second command value. As a result, the period of time that is less burdensome for the system that adjusts the supply and demand of the electricity can be caused to be as long as possible.

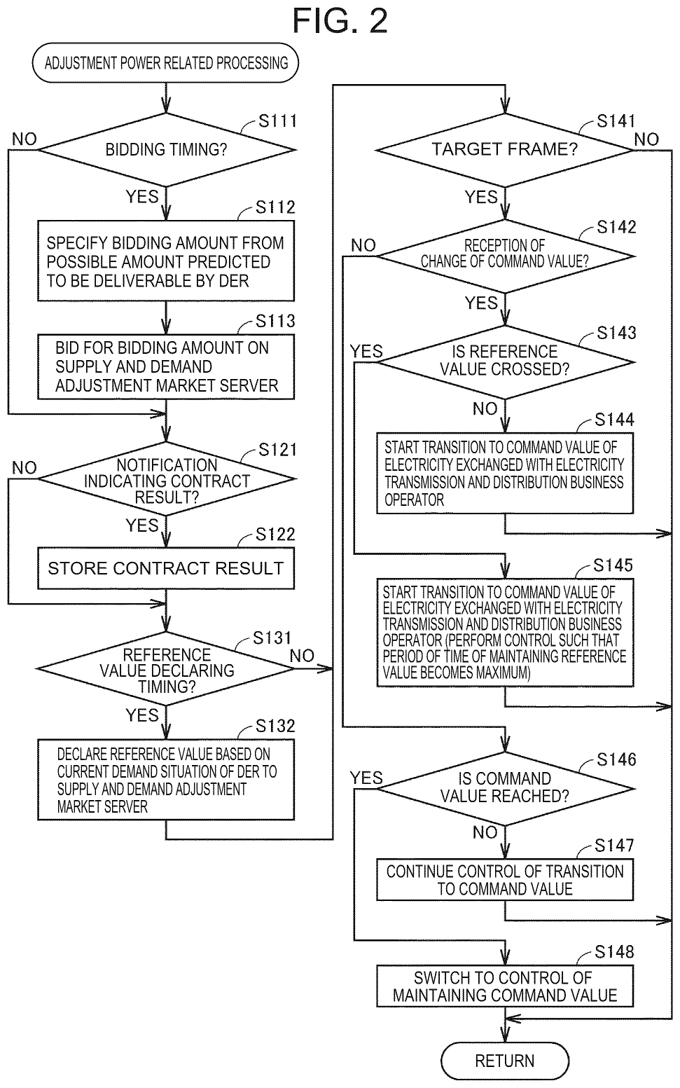

FIG. 2 is a flowchart showing a flow of adjustment power related processing executed by an aggregator server 100 in the present embodiment. With reference to FIG. 2, the processor 110 of the aggregator server 100 determines whether the current time is a bidding timing (Step S111). The bidding timing is specific time such as predetermined hours before deadline time for bidding. In the case of the tertiary adjustment power (2), the bidding time is from 12 o'clock to 14 o'clock on a previous day. Therefore, the deadline time for bidding is 13 o'clock that is one hour before 14 o'clock, for example.

When it is determined that the current time is the bidding timing (YES in Step S111), the processor 110 specifies a bidding amount and a bidding price from a possible amount predicted to be deliverable by the DER 310 (or the DSR 210) in a time frame that is a bidding target (Step S112). The possible amount is the adjustment power of the demand for the electricity predicted to be reducible that is predicted from information of the DER 310. Electricity including a safety factor in addition to the possible amount is set as the tertiary adjustment power (2), and the bidding amount is defined. Then, the processor 110 bids the bidding amount and the bidding price specified in Step S112 on the supply and demand adjustment market server 400 (Step S113).

When it is determined that the current time is not the bidding timing (NO in Step S111) or after Step S113, the processor 110 determines whether a notification indicating a contract result is given from the supply and demand adjustment market server 400 (Step S121). The contract amount of the tertiary adjustment power (2) is specified within a range of the bidding amount. When it is determined that the notification of the contract result is given (YES in Step S121), the memory 120 or the auxiliary storage apparatus 160 is caused to store the contract result therein (Step S122).

When it is determined that it is not the timing at which the notification of the contract result is given (NO in Step S121) or after Step S122, the processor 110 determines whether the current time is a timing of declaring the reference value (Step S131). The timing of declaring the reference value is specific time such as predetermined minutes before deadline time for declaring the reference value. In the case of the tertiary adjustment power (2), the deadline time is one hour before a target frame starts, for example, 30 minutes before the deadline time.

When it is determined that the current time is the timing of declaring the reference value (YES in Step S131), the processor 110 declares a demand (when the DER 310 is an electrified vehicle, charging electricity for the electrified vehicle that needs to be charged) necessary for the frame of the tertiary adjustment power (2) to the supply and demand adjustment market server 400 as the reference value (Step S132).

When it is determined that the current time is not the timing of declaring the reference value (NO in Step S131) or after Step S132, the processor 110 determines whether the current time is starting time of the target frame (Step S141). When it is determined that the current time is not the starting time of the target frame (NO in Step S141), the processor 110 returns the processing to be executed to processing in an upper level that is a caller of the adjustment power related processing.

Meanwhile, when it is determined that the current time is the starting time of the target frame (YES in Step S141), the processor 110 determines whether a command for changing the command value of the adjustment power of the supply and demand electricity with respect to the electricity transmission and distribution business operator 50 that is a business partner regarding the adjustment power of the electricity based on the contract result is received from the electricity transmission and distribution business operator server 500 (Step S142).

When it is determined that the command for changing the command value is received (YES in Step S142), the processor 110 determines whether the reference value declared in Step S132 is crossed at the time of transition of the supply and demand electricity from the command value before the change to the command value after the change (Step S143).

When it is determined that the reference value is not crossed at the time of transition (NO in Step S143), the processor 110 starts the control of the DER 310 (or the DSR 210) for causing transition to the command value of supply and demand of electricity to be exchanged with the electricity transmission and distribution business operator 50 (Step S144), and returns the processing to be executed to processing in an upper level that is the caller of the adjustment power related processing. In this control, the transition to the command value after the change needs to be completed within a period of responding time, and transition may be performed at the maximum controllable speed. The maximum controllable speed is specified by an experiment, a trial, or a simulation in advance.

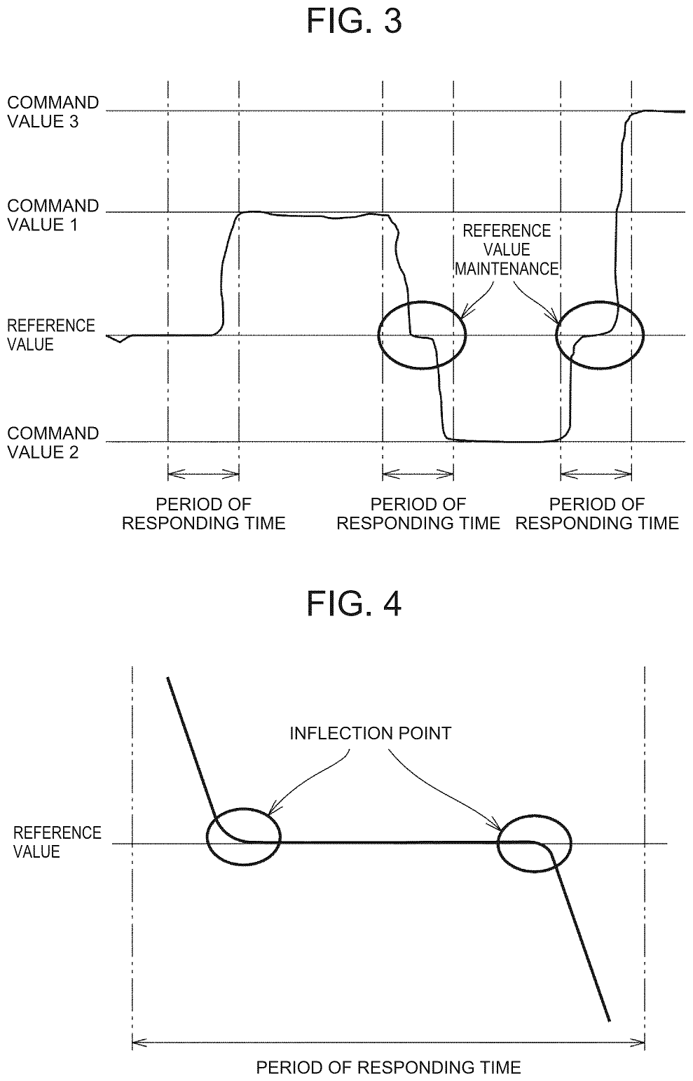

FIG. 3 is a diagram showing a change of supply and demand electricity exchanged with the electricity transmission and distribution business operator 50 in the present embodiment. With reference to FIG. 3, when there is a command for changing the command value from the reference value to a command value 1, the reference value is not crossed at the time of transition, and hence the supply and demand electricity is changed at the maximum controllable speed within the period of responding time.

Returning to FIG. 2, when it is determined that the reference value is crossed at the time of transition (YES in Step S143), the processor 110 starts the control of the DER 310 (or the DSR 210) for causing transition to the command value of supply and demand of electricity to be exchanged with the electricity transmission and distribution business operator, controls the period of time of maintaining the reference value to be the maximum in this transition (Step S145), and returns the processing to be executed to processing in an upper level that is the caller of the adjustment power related processing. In this control, the transition to the command value after the change needs to be completed within the period of responding time. In the transition from the command value before the change to the reference value and the transition from the reference value to the command value after the change, it is desired that the supply and demand electricity be changed at the maximum controllable speed. The maximum controllable speed is specified by an experiment, a trial, or a simulation in advance.

With reference to FIG. 3 again, when there is a command for changing the command value from the command value 1 to a command value 2 and there is a command for changing the command value from the command value 2 to a command value 3, the reference value is crossed at the time of transition. Therefore, the supply and demand electricity is changed at the maximum controllable speed within the period of responding time, and the period of time of maintaining the reference value is controlled to be as long as possible.

In a case where the reference value is not crossed at the time of transition, the command value before the change is linearly changed to the command value after the change. FIG. 4 is an enlarged diagram showing a change before and after the reference value in a case where the reference value is crossed in the change of the supply and demand electricity exchanged with the electricity transmission and distribution business operator 50 in the present embodiment. With reference to FIG. 4, meanwhile, in a case where the reference value is crossed at the time of transition, the change is linearly made from the command value before the change to the reference value and from the reference value to the reference value after the change, and there are inflection points before and after the reference value. As a result, the period of time of maintaining the reference value is provided.

Returning to FIG. 2, meanwhile, when it is determined that it is not a timing at which the command for changing the command value is received (NO in Step S142), the processor 110 determines whether the command value after the change is reached in the transition to the command value after the change (Step S146). When it is determined that the command value after the change is not reached (NO in Step S146), the processor 110 continues the control of transitioning to the command value after the change (Step S147), and returns the processing to be executed to processing in an upper level that is the caller of the adjustment power related processing.

Meanwhile, when it is determined that the command value after the change is reached (YES in Step S146), the processor 110 switches the control of the DER 310 (or the DSR 210) such that the supply and demand electricity maintains the command value (Step S148), and returns the processing to be executed to processing in an upper level that is the caller of the adjustment power related processing.

### Modified Examples

(1) In the embodiment described above, as shown in FIG. 1 and the like, the DER 310 (or the DSR 210) may mainly include a demand facility such as a chargeable electrified vehicle and supplementally include an electricity accumulation facility such as a chargeable and dischargeable electrified vehicle. However, limitation is not made to the above, and the DER 310 (or the DSR 210) may include at least one of a demand facility, an electricity accumulation facility, and an electricity generation facility.

(2) In the embodiment described above, as shown in FIG. 2 and the like, the aggregator 10 exchanges the supply and demand electricity with the electricity transmission and distribution business operator 50. However, limitation is not made to the above, and a trading business operator or an individual such as the electricity generation business operator 60, the consumer 20, or the retail electricity business operator 30 may exchange the supply and demand electricity with the electricity transmission and distribution business operator 50.

(3) In the embodiment described above, as shown in Step S145 in FIG. 2, in a case where the reference value is crossed when the supply and demand electricity is caused to transition from the command value before the change to the command value after the change, control is performed such that the period of time of maintaining the reference value becomes the maximum. However, limitation is not made to the above, and the period of time of maintaining the reference value only needs to at least exceed 0, and may be any period of time as long as the period of time is a period of time between 0 to the maximum. However, the period of time is desired to be as long as possible.

(4) In the embodiment described above, the electricity management apparatus that manages the adjustment power of the electricity delivered to the electricity transmission and distribution business operator 50 by the trading business operator such as the aggregator 10 or the electricity generation business operator 60 is the aggregator server 100. However, limitation is not made to the above, and the electricity management apparatus may be other apparatuses, and may be the supply and demand adjustment market server 400, may be the electricity generation business operator server 600, may be the retail electricity business operator server 300, or may be the electricity transmission and distribution business operator server 500, for example.

### CONCLUSION

(1) As shown in FIG. 1, the electricity management apparatus (for example, the aggregator server 100, the electricity generation business operator server 600) is an apparatus that manages the adjustment power of the electricity delivered to the electricity transmission and distribution business operator 50 by the trading business operator (for example, the aggregator 10, the electricity generation business operator 60). As shown in FIG. 1, the electricity management apparatus can control the adjustment system (for example, the DER 310, the DSR 210) of the supply and demand of electricity and includes the memory 120 that stores therein a predetermined program (for example, the program of the adjustment power related processing shown in FIG. 2), and the processor 110 that executes the predetermined program.

As shown in FIG. 2 to FIG. 4, the processor 110 controls, by executing the predetermined program, the adjustment system so as to go through a period of time of maintaining the reference value of supply and demand of electricity by the adjustment system declared in advance in a case where the reference value is crossed when the command value of supply and demand electricity to the adjustment system transitions from the first command value before change to the second command value after change (for example, Step S145).

As a result, it becomes possible to go through a period of time of maintaining the reference value in a case where the reference value is crossed when the command value of the supply and demand electricity to the adjustment system transitions from the first command value to the second command value. As a result, the period of time that is less burdensome for the system that adjusts the supply and demand of the electricity can be caused to be as long as possible.

(2) As shown in FIG. 2 and FIG. 3, the processor 110 may control, by executing the predetermined program, the adjustment system with a goal of linearly changing the first command value to the second command value when the reference value of supply and demand of electricity by the adjustment system declared in advance is not crossed when the command value of supply and demand of electricity to the adjustment system transitions from the first command value before change to the second command value after change (for example, Step S144). As a result, it becomes possible to change the first command value to the second command value by a simple control.

(3) As shown in FIG. 2 to FIG. 4, the processor 110 may control the speed of changing the supply and demand of electricity by the adjustment system in the period of time of transitioning from the first command value to the reference value and the period of time of transitioning from the reference value to the second command value to be a controllable maximum speed when the adjustment system is controlled to go through the period of time of maintaining the reference value (for example, Step S145).

As a result, the period of time that is less burdensome for the system that adjusts the supply and demand of the electricity can be caused to be further longer.

It is to be understood that the embodiments disclosed above are merely examples in all aspects and in no way intended to limit the disclosure. The scope of the present disclosure is defined by the scope of the claims. All modifications made within the scope and spirit equivalent to those of the claims are intended to be included in the disclosure.

What is claimed is:

1. An electricity management apparatus that manages adjustment power of electricity delivered to an electricity transmission and distribution business operator by a trading business operator, the electricity management apparatus being capable of controlling an adjustment system of supply and demand of electricity, the electricity management apparatus comprising:
a memory that stores a predetermined program in the memory; and
a processor that executes the predetermined program, wherein the processor controls, by executing the predetermined program, the adjustment system so as to go through a period of time of maintaining a reference value of supply and demand of electricity by the adjustment system in a case where the reference value is crossed when a command value of supply and demand electricity to the adjustment system transitions from a first command value before change to a second command value after change.

2. The electricity management apparatus according to claim 1, wherein the processor controls, by executing the predetermined program, the adjustment system with a goal of linearly changing the first command value to the second command value in a case where the reference value of supply and demand of electricity by the adjustment system is not crossed when the command value of supply and demand of electricity to the adjustment system transitions from the first command value before change to the second command value after change.

3. The electricity management apparatus according to claim 1, wherein the processor controls a speed of changing the supply and demand of electricity by the adjustment system in a period of time of transitioning from the first command value to the reference value and a period of time of transitioning from the reference value to the second command value to be a controllable maximum speed when the adjustment system is controlled to go through the period of time of maintaining the reference value.
